(19) United States
(12) Patent Application Publication
(10) Pub. No.: US 2010/0111346 A1
(43) Pub. Date: May 6, 2010

(54) ELECTRONIC DEVICE INCORPORATING SOUND RECEIVING MEMBER AND METHOD OF MANUFACTURING THE SAME

(75) Inventors: PO-YAO HSIAO, Tu-Cheng (TW); SHENG-KAI HSU, Tu-Cheng (TW); KUEN-YING OU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXCONN TECHNOLOGY CO., LTD., Tu-Cheng (TW)

(21) Appl. No.: 12/400,775

(22) Filed: Mar. 9, 2009

(30) Foreign Application Priority Data
Oct. 30, 2008 (CN) 200810305309.6

(51) Int. Cl. H04R 11/04; H04R 31/00

(52) U.S. Cl. 381/365; 29/592.1; 29/594

(57) ABSTRACT

An electronic device includes a casing defining a sound receiving chamber therein, and a microphone accommodated in the sound receiving chamber. The sound receiving chamber has an arcuate surface being part of an outer elliptical surface. The microphone is located at a focus of the elliptical surface, with a sound receiving surface of the microphone facing the sound receiving chamber. The other focus of the elliptical surface is disposed at a position out of the sound receiving chamber.

### BACKGROUND

1. Technical Field

The disclosure relates to electronic devices, and particularly to an electronic device incorporating a sound receiving member having sound directivity and a method for manufacturing the electronic device.

2. Description of Related Art

With the continuing development of technology, electronic devices incorporating sound receiving members, such as microphones, are widely used. The microphone is often an acoustic-to-electric transducer or sensor that converts sound into an electrical signal. Every microphone has a property known as directionality, referring to the microphone's receptivity to sound from various directions.

Unidirectional microphones, receptive to sounds from only one direction, are very versatile microphones, ideal for general use. Specifically, a sound receiving member of the unidirectional microphone has higher receptivity in one direction than others. Increased receptivity in the predetermined direction improves clarity of a received electrical signal. Thus, it is important to improve receptivity.

What is needed, therefore, is an electronic device having a sound receiving member which can overcome the described limitations.

### BRIEF DESCRIPTION OF THE DRAWINGS

Many aspects of the present electronic device can be better understood with reference to the following drawings. The components in the drawings are not necessarily drawn to scale, the emphasis instead being placed upon clearly illustrating the principles of the disclosed electronic device. Moreover, in the drawings, like reference numerals designate corresponding parts throughout the several views.

FIG. 1 is a schematic view showing properties of an ellipse.

FIG. 2 is an isometric view of an electronic device in accordance with the disclosure.

FIG. 3 is an enlarged view showing a sound receiving member of the electronic device of FIG. 2.

FIG. 4 is a cross-section of the electronic device of FIG. 2, taken along line IV-IV, showing an operating principle of the electronic device.

FIG. 5 is an enlarged view of a circle portion V of the electronic device of FIG. 4.

FIGS. 6 to 8 are schematic views showing a method for manufacturing the sound receiving member of the electronic device of FIG. 2.

### DETAILED DESCRIPTION

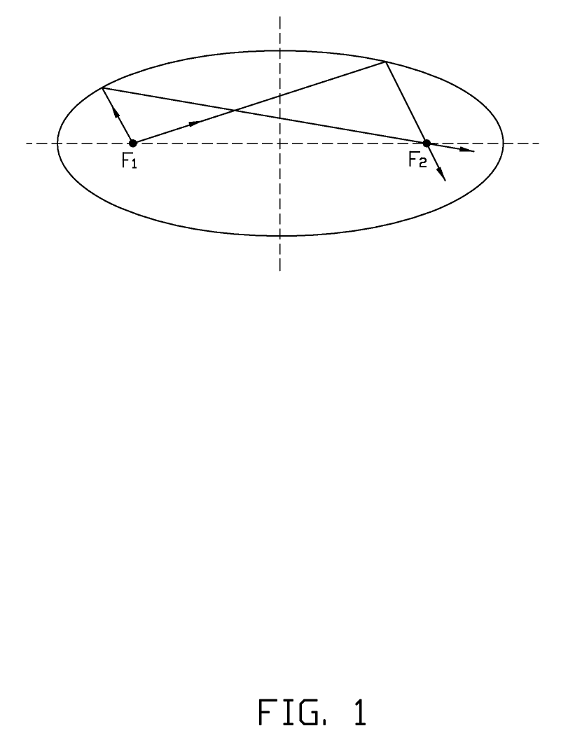

FIG. 1 illuminates properties of an ellipse. The ellipse defines two foci F₁, F₂. It is known that waves, such as light or sound, from one focus F₁ (F₂) are reflected by the ellipse, and then pass through the other focus F₂ (F₁).

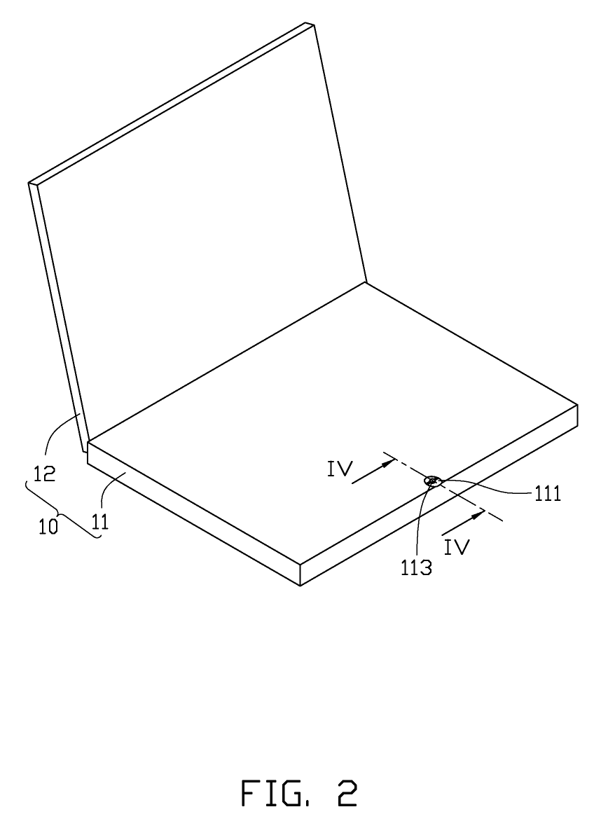

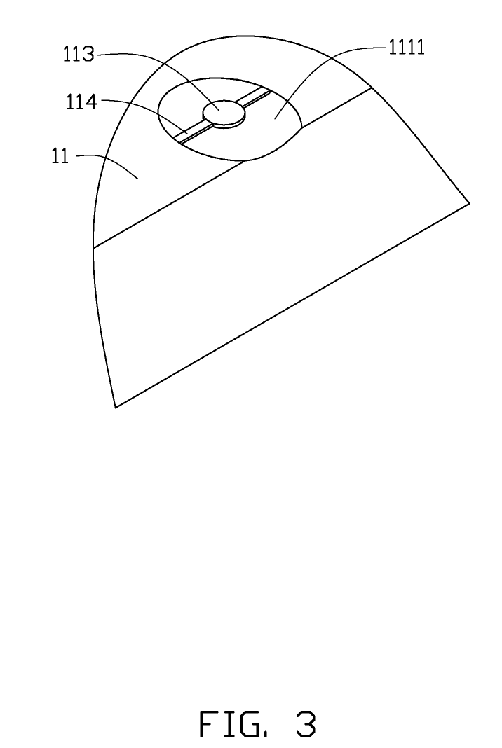

Referring to FIGS. 2 and 3, an electronic device in accordance with the disclosure is shown. The electronic device can be a video meeting system, mobile phone or other. In this embodiment, the electronic device is a notebook computer 10. The notebook computer 10 includes a main body 11 and a cover 12 hinging on the main body 11 at a rear side thereof. The main body 11 is provided with a keyboard (not shown) accepting input. The cover 12 displays image and video corresponding to the input.

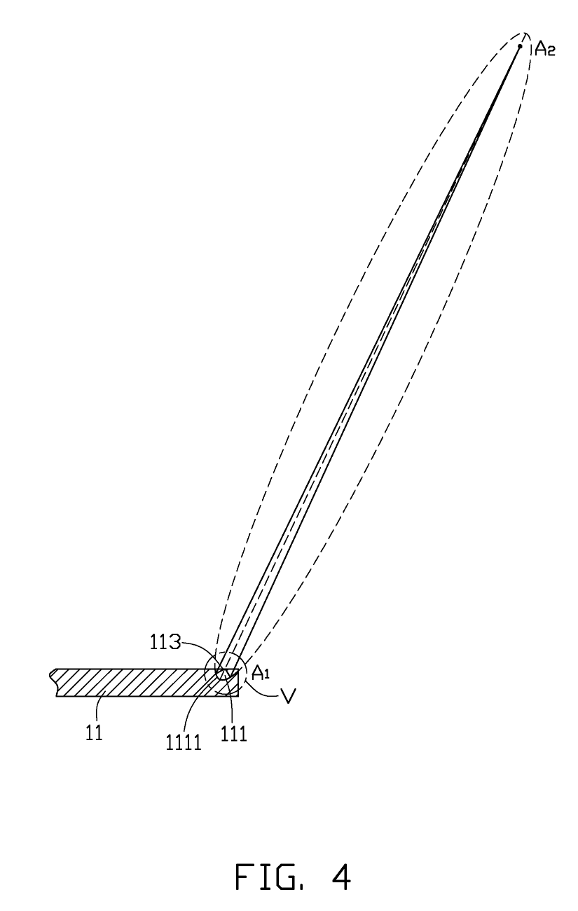

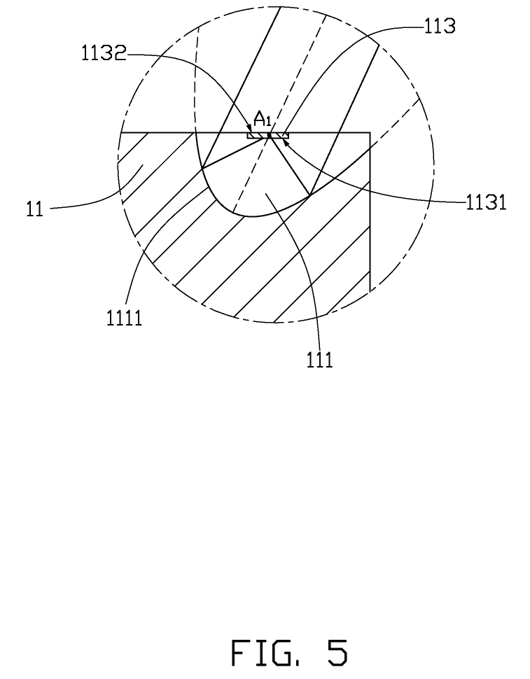

The main body 11 defines a sound receiving chamber 111 therein at a middle of a front side of a top face thereof. The sound receiving chamber 111 is surrounded by an arcuate side surface 1111 which is part of an outer elliptical surface. The elliptical surface has a first focus A₁ and a second focus A₂. The first focus A₁ is located in the sound receiving chamber 111, and the second focus A₂ is located beyond and above the notebook computer 10. A line defined by the foci A₁, A₂ is slantwise angled to the top face of the main body 11. A microphone 113 is accommodated in the sound receiving chamber 111. The microphone 113 and the arcuate side surface 1111 defining the sound receiving chamber 111 cooperatively form a sound receiving member of the notebook computer 10. The microphone 113 is fixed on the main body 11 via a pair of arms 114. The arms 114 are also received in the sound receiving chamber 111, and electrically connect the microphone 113 with a circuit board in the main body 11. Referring to FIGS. 4 and 5, the microphone 113 is located at the first focus Al of the elliptical surface. The microphone 113 has a sound receiving surface 1131 and a sound reflecting surface 1132 opposite thereto. The sound receiving surface 1131 faces the sound receiving chamber 111, and the sound reflecting surface 1132 is coplanar with the top surface of the main body 11.

Sound from a source located at the second focus A₂ of the elliptical surface, according to the optical and acoustic properties of the ellipse illustrated in FIG. 1, is reflected by the side surface 1111 of the sound receiving chamber 111, and then passes the focus A₁ of the elliptical surface, namely the location of the microphone 113. Since the sound receiving surface 1131 of the microphone 113 faces the sound receiving chamber 111, the sound reflected by the side surface 1111 of the sound receiving chamber 111 is all received by the microphone 113. Meanwhile, the microphone 113 has high receptivity with respect to the sound from the sound source at the focus A₂ of the elliptical surface, whereby surrounding cacophony from other positions cannot easily interfere with the desired sound from the focus A₂ of the elliptical surface. Thus, quality of the sound received by the electronic device is improved.

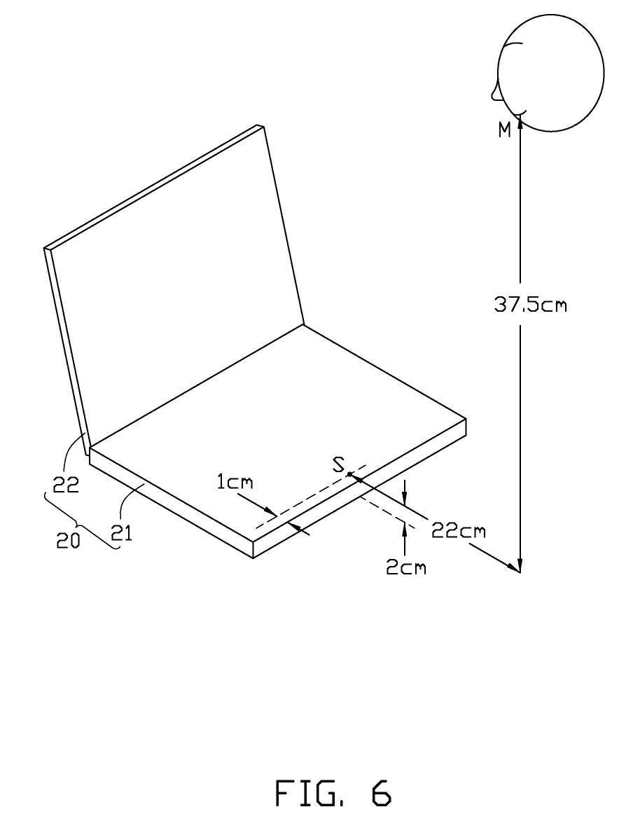

FIGS. 6 to 8 show a method of manufacturing an electronic device.

Referring to FIG. 6, a typical notebook computer 20 is provided. The notebook computer 20 includes a main body 21 and a cover 22 hinging on the main body 21 at a rear side thereof. The main body 21 defines a sound receiving location S thereon. A sound source location M, such as a user, is defined beyond and above the notebook computer 20. The notebook computer 20 receives sound from the sound source location M at the sound receiving location S. According to a criterion of ISO 3744, perpendicular and horizontal distances between a bottom end of a front flange of the main body 21 and an ear of a user are preferably 45cm and 25cm, respectively. Generally a perpendicular distance and a horizontal distance between the ear and the sound source location M are respectively 5.5 cm and 4 cm. A horizontal distance between the sound receiving location S and the front flange of the main body 21 is 1 cm. Thickness of the main body 21 is 2 cm. Accordingly, a perpendicular distance and a horizontal distance between the sound receiving location S and the sound source location M are respectively 37.5 cm and 22 cm.

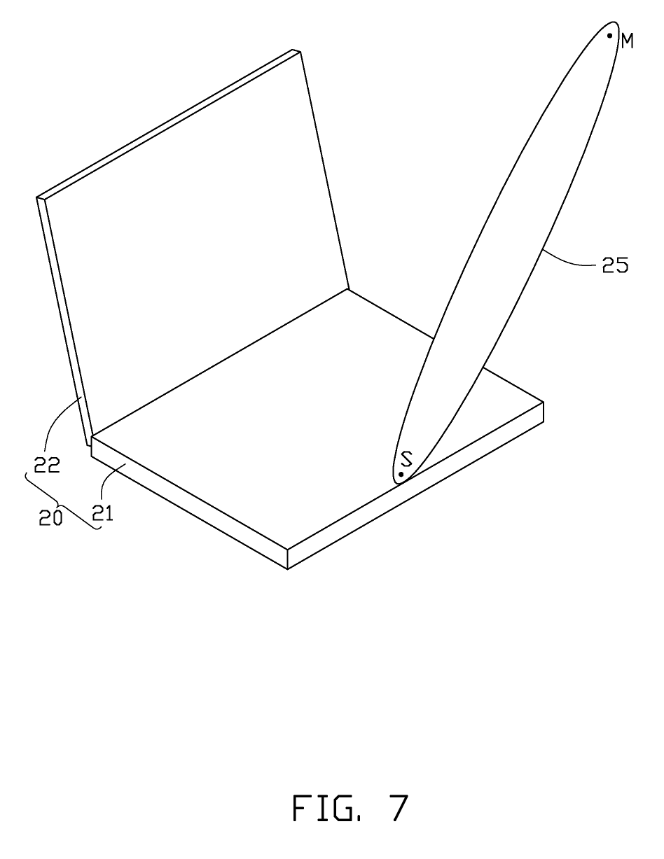

Referring to FIG. 7, the sound receiving and sound source locations S, M act as two foci forming an elliptical surface 25, with a part of the elliptical surface 25 extending into the main body 21.

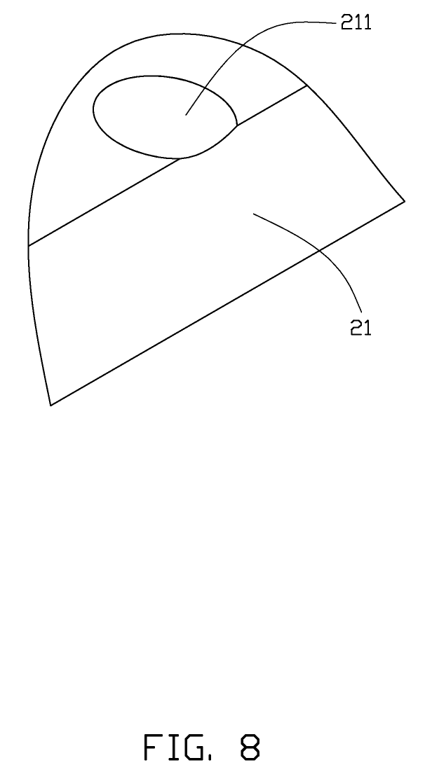

Referring to FIG. 8, a space occupied by part of the elliptical surface 25 extends into the main body 21 to define a sound receiving chamber 211. A microphone 113 illustrated in FIG. 3 is disposed at the sound receiving location S, and a pair of arms 114 illustrated in FIG. 3 connect the microphone 113 with the main body 21. Thus, an electronic device having the sound receiving member in accordance with the disclosure is formed.

Alternatively, in the method of manufacturing the electronic device, corresponding to varying user dimensions, the perpendicular and horizontal distances between the location of the ear and the sound source location M, the horizontal distance between the sound receiving location S and the front flange of the main body 21, and the thickness of the main body 21 can support position variation from −1 to 1 cm. Accordingly, the perpendicular distance between the location S and the location M can be in a range of from 35.5 to 39.5 cm, and the horizontal distance between the location S and the location M can be from 20 to 24 cm.

It is believed that the disclosure and its advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. An electronic device comprising:
a casing defining a sound receiving chamber having an arcuate surface being part of an outer elliptical surface; and
a microphone accommodated in the sound receiving chamber and located at a first focus of the elliptical surface, with a sound receiving surface of the microphone facing the sound receiving chamber, with a second focus of the elliptical surface being disposed out of the sound receiving chamber.

2. The electronic device of claim 1, wherein a perpendicular distance between a location of the microphone and the second focus out of the sound receiving chamber is from 35.5 to 39.5 cm, and a horizontal distance between the location of the microphone and the second focus is from 20 to 24 cm.

3. The electronic device of claim 2, wherein the perpendicular distance and the horizontal distance between the location of the microphone and the focus out of the sound receiving chamber are 37.5 cm and 22 cm, respectively.

4. The electronic device of claim 1, further comprising at least one arm interconnecting the microphone and the casing.

5. The electronic device of claim 1, wherein the electronic device is a notebook computer, the notebook computer comprising a main body and a cover hinging on the main body at a rear side thereof, the main body defining the sound receiving chamber in a front side of a top face of a casing thereof.

6. The electronic device of claim 5, wherein the microphone further comprises a sound reflecting surface opposite to the sound receiving chamber, and the sound reflecting surface is coplanar with the top surface of the casing of the main body.

7. A method of manufacturing an electronic device comprising:
providing an electronic device defining a sound receiving location;
defining a sound source location out of the electronic device;
employing the sound source location and the sound receiving location as two foci of an elliptical surface, with a part of the elliptical surface extending into the electronic device;
utilizing a space occupied by the part of the elliptical surface in the electronic device as a sound receiving chamber; and
disposing a microphone at the sound receiving location, with a sound receiving surface of the microphone facing the sound receiving chamber.

8. The method of manufacturing an electronic device of claim 7, wherein a perpendicular distance and a horizontal distance between the sound receiving location and the sound source location are from 35.5 to 39.5 cm and from 20 to 24 cm, respectively.

9. The method of manufacturing an electronic device of claim 8, wherein a perpendicular distance between a location of the microphone and the other focus out of the sound receiving chamber is from 35.5 to 39.5 cm, and a horizontal distance between the location of the microphone and the other focus out of the sound receiving chamber is from 20 to 24 cm.

10. The method of manufacturing an electronic device of claim 7, further comprising providing at least one arm fixing the microphone in the sound receiving chamber.

11. The method of manufacturing an electronic device of claim 7, wherein the electronic device is a notebook computer, the notebook computer comprises a main body and a cover hinging on the main body at a rear side thereof, and the main body defines the sound receiving chamber in a front side of a top face thereof.

12. The method of manufacturing an electronic device of claim 11, wherein the microphone further comprises a sound reflecting surface opposite to the sound receiving chamber, and the sound reflecting surface is coplanar with the top surface of the main body.

13. The method of manufacturing an electronic device of claim 11, wherein a line interconnecting the two foci is slantwise angled to the top face of the main body.
